(19) United States
(12) Patent Application Publication
(10) Pub. No.: US 2021/0279651 A1
(43) Pub. Date: Sep. 9, 2021

(54) SHARED FLIGHT PLATFORM

(71) Applicant: JetSmarter Inc., Fort Lauderdale, FL (US)

(72) Inventors: Sergey Petrossov, Fort Lauderdale, FL (US); Mikhail Kirsanov, Fort Lauderdale, FL (US)

(21) Appl. No.: 17/330,509

(22) Filed: May 26, 2021

Related U.S. Application Data
(63) Continuation of application No. PCT/US2019/022386, filed on Mar. 15, 2019.
(60) Provisional application No. 62/771,788, filed on Nov. 27, 2018.

(51) Int. Cl. G06Q 10/02; G06Q 50/14; G06Q 30/06; G06Q 10/06; H04L 29/08

(52) U.S. Cl. CPC G06Q 10/02; G06Q 50/14; G06F 3/0482; G06Q 10/06315; H04L 67/26; G06Q 30/0641

(57) ABSTRACT

Methods, systems, and apparatus, including computer programs encoded on a computer storage medium, that facilitate a shared flight marketplace that enables creators to create shared flights and finders claim spots on the shared flights. In one aspect, a method includes receiving, by one or more computers and from users operating client devices, data submissions that modify an availability of spots on private jets. For each modification of the spots caused by the submitted data, the computer(s) determine, based on a type of modification made to the availability of the spots, an effect of the modification on the availability of various spots on segments between various geographic locations. One or more parameters that restrict access to the other spots are modified based on the effect of the modification. The modification includes adjusting a creation requirement for users to create a new private jet segment based on the effect of the modification.

### CROSS-REFERENCE TO RELATED APPLICATION

This application is a continuation of International Application No. PCT/US2019/022386, filed on Mar. 15, 2019, which claims priority to U.S. Application Ser. No. 62/771,788, filed on Nov. 27, 2018. Each of the foregoing applications is hereby incorporated by reference.

### TECHNICAL FIELD

This specification relates to a shared flight platform that enables creators to create shared flights and finders claim spots on the shared flights.

### BACKGROUND

Historically, options for traveling between an origin and a destination have been limited to commercial public options in which individual spots (e.g., seats) are acquired by anyone and private options in which all spots in an aircraft or other mode of transport are acquired together by an individual.

### SUMMARY

In general, one innovative aspect of the subject matter described in this specification can be embodied in methods that include receiving, by one or more computers and from users operating client devices, data submissions that modify an availability of spots on private jets. For each modification of the spots caused by the submitted data, a determination is made, based on a type of modification made to the availability of the spots, an effect of the modification on the availability of various spots on segments between various geographic locations and the one or more computers modify one or more parameters that restrict access to the other spots based on the effect of the modification. The modifying can include adjusting a creation requirement for users to create a new private jet segment based on the effect of the modification. The one or more computers communicate the modified one or more parameters to users through a user interface that presents access restrictions for various spots on private jets and through a push message alert to at least one of the users in response to the modification of the one or more parameters. Other embodiments of this aspect include corresponding systems, apparatus, and computer programs, configured to perform the actions of the methods, encoded on computer storage devices.

These and other embodiments can each optionally include one or more of the following features. In some aspects, determining the effect can include determining that the modification causes a decrease in available spots for a given private jet segment based on a user claiming a spot on the given private jet segment. Modifying the one or more parameters can include decreasing an amount required to create a new private jet segment having a same route as the given private jet segment based on the decreased availability of spots on segments on the same route in response to the user claiming the spot.

In some aspects, determining the effect can include determining that the modification is a user creating a new private jet segment for a given route that causes an increase in available spots on private jet segments along the given route. Modifying the one or more parameters can include increasing the creation requirement for a user to create a new private jet segment along the given route based on the increased availability of spots on private jet segments on the given route. In some aspects, increasing the creation requirement can include increasing the creation requirement based on a quantity of additional available spots on the given route added by the new private jet segment.

In some aspects, the new private jet segment can be a new conditional private jet segment that is conditional on at least a threshold number of spots on the new conditional private jet segment being claimed. A determination can be made that an expiration time for the conditional private jet segment has elapsed. The new conditional private jet segment can be cancelled in response to the expiration time elapsing causing decrease in available spots on private jet segments along the given route. The creation requirement for a user to create a new private jet segment along the given route can be decreased based on the decreased availability of spots on private jet segments on the given route.

Some aspects can include, in response to determining that the modification is a user creating a new private jet segment along a given route, identifying an aircraft that is available to complete the private jet segment along the given route. The aircraft can be selected from among a candidate fleet including an owned private aircraft fleet and a third party private aircraft fleet owned by a third party.

In some aspects, determining the effect can include determining that the modification is a user converting a private charter segment created by the user for a given route to a shared charter segment on which other users can claim a spot and determining that the shared charter segment includes one or more available spots that causes an increase in available spots on private jet segments along the given route. Modifying the one or more parameters can include increasing the creation requirement for users to create a new private jet segment along the given route based on the increased availability of spots on private jet segments on the given route.

In some aspects, determining the effect can include determining that the modification is a user claiming a spot on a private jet segment for a given route that causes a decrease in available spots on private jet segments along the given route. Modifying the one or more parameters can include determining that there is at least one remaining available spot on the private jet segment and increasing a spot claiming requirement for users to claim a spot on the private jet segment based on the decreased availability of spots on private jet segments on the given route.

In some aspects, determining the effect can include determining that the modification is a user adding a private jet segment for a given route to a segment list of the user that causes an increase in a number of users that have added the private jet segment to segment lists. Modifying the one or more parameters can include increasing a spot claiming requirement for users to claim a spot on the private jet segment based on the increase in the number of users that have added private jet segments for the given route to segment lists.

The subject matter described and claimed in this document can provide one or more of the following advantages. The shared flight marketplace described herein enables groups of users to arrange and share the costs of private jet flights, e.g., without having to directly communicate with or even knowing each other. This unconventional approach to air travel makes private jet travel accessible to users that would not be willing to pay the entire cost for a private jet charter. It also connects people that want to travel on private jet flights, but not pay the full price for private charters. The shared flight marketplace provides a variety of different types of private jet flights from the same entry point (e.g., using the same application and its user interfaces) so that users can create a type of private jet segment that meets the user's unique needs.

The shared flight marketplace provides a dynamic platform that responds to user initiated activity. The user initiated activity that is enabled by the shared flight marketplace can include (among other things) the ability for users to create new private jet flights, make spots on those private jet flights available to other users, and claim spots on various existing private jet flights. Each of these activities can be detected and/or tracked by the shared flight marketplace. Furthermore, each of these activities can trigger adjustments to parameters that restrict access to and/or place conditions on requirements for creating additional private jet flights and/or claiming spots on existing private jet flights. These adjustments can take place in real time (or near real time), thereby creating a dynamic marketplace that automatically reacts to market conditions. This automated marketplace provides the reality of an efficient marketplace for shared private jets, which simply isn't provided by traditional private jet services, and can't be provided absent a shared private jet marketplace because such an efficient marketplace requires continuous consideration of each user's action at all times, which simply isn't possible absent an automated shared private jet marketplace.

The parameters that restrict access to spots (e.g., seats) on the private jet segments can be adjusted in response user modifications to the availability of spots available on private jets, thereby enabling real time availability updates that are provided to users. In some situations, the adjustments can be made in response to changes in the number of available spots on the segments to encourage the creation of additional spots to meet the demand of the users. For example, by reducing creation requirements for creating a new client-initiated private jet segment on a given route in response to a decrease in the number of available spots on the route, users are more likely to create new private jet segments on the route, which creates more private jet inventory for all of the users of the shared flight marketplace.

As discussed in detail throughout this document, the shared flight marketplace can provide various additional capabilities that improve over traditional flight reservation systems (e.g., commercial flight systems). For example, the shared flight marketplace can be used to implement shared flight creation by users, crowdsourced flights, the ability for users to obtain rebates for seats claimed by other users, the ability for a user (i.e., the creator of the flight) to set the price required for other users to claim seats on the flight, the ability for users to be intelligently informed as to private jet flights that are relevant to that user (e.g., based on origin geographic location, destination geographic location, user attributes and/or flight history, and other factors), and the ability for users to claim seats on existing private jet flights. The shared flight marketplace also provides a direct user feedback mechanism that enables users to rate their flight experience, which can then be used to adjust prices for future flights (e.g., flights on aircrafts from a specific operator, over a specific route, etc.) according to the aggregate user rating (e.g., decrease prices for lower rated operators/routes and/or increase for higher rated operators/routes).

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a shared flight marketplace system provides a shared flight marketplace that enables clients to arrange private jet travel.

FIGS. 2A-2F are screenshots of example graphical interfaces of a shared flight marketplace that enable clients to create private jet segments and claim spots on private jet segments.

FIG. 3 is a screenshot of an example graphical interface of a shared flight marketplace that presents push notifications sent to a client.

FIG. 4 is a flow chart of an example process for updating parameters that restrict access to spots on private jet segments based on modifications made to spots on private jet segments and communicating the updated parameters to users.

Like reference numbers and designations in the various drawings indicate like elements.

### DETAILED DESCRIPTION

This document describes methods, systems, devices and computer readable medium that facilitate an electronic platform that hosts a shared flight marketplace. People who participate in the shared flight marketplace can create various types of shared private jet flights and claim spots (e.g., seats) to travel on the shared private jet flights. The shared flight marketplace also allows the participants to co-create private jet segments using crowdsourcing techniques. As described below, the various types of private jet flights that can be created in the shared flight marketplace can include client-initiated custom shuttles, conditional shuttles (e.g., that are crowdsourced), client-initiated private charters, client-initiated shared charters, service provider scheduled shuttles, and/or other appropriate types flights that can be completed using private jets rather than traditional commercial aircraft.

The term private jet segment refers to a private jet flight that carries clients between two locations on a private jet. While any appropriate type of private (e.g., non-commercial) aircraft (e.g., a propeller aircraft, a jet aircraft, or a rotorcraft) can be used, they will be collectively referred to using the term “jet” for brevity. A spot refers to seat or other appropriate area of occupancy for a client on a private jet.

A client (also referred to herein as a user) is a person who participates in the shared flight marketplace. For example, a client can be a person who travels on one or more private jet segments provided through the shared flight marketplace. The shared flight marketplace can be operated by a shared private jet service provider. A client can be a member of a shared private jet service provided by the shared private jet service provider or a non-member that, for example, uses an application to claim a spot on private jet segments and/or create private jet segments. As used throughout this document, a creator refers to a client that creates a private jet segment and a finder refers to a client that claims a spot on a private jet segment. A client can be both a creator and a finder. For example, a client can claim a spot on a private jet segment and create another private jet segment.

A client can create a client-initiated shuttle by selecting a route from a pre-specified set of routes between two locations (e.g., as specified by a provider of the service). A client can also create a conditional shuttle by designating the client-initiated shuttle as a conditional shuttle that is conditional on at least a specified number of spots being claimed by one or more other co-creators before the shuttle can be confirmed. A client can create a client-initiated private charter by freely specifying both the origin and destination for the charter rather than selecting from the pre-specified set of routes. A client can create a client-initiated shared charter by allowing other clients to claim a spot on the charter, e.g., by converting a client-initiated charter to a client-initiated shared charter. Each of these types of private jet segments are described in more detail below.

The shared flight marketplace is an electronic platform that connects users around the globe, and enables users that may not know each other to arrange and share the costs of private jet flights, e.g., without communicating with each other. For example, a client can create one of various types of private jet segments and make spots on the segment available to other clients so that the clients can share the cost for the segment. Notification of the created private jet segments can be provided to other clients using push notifications or updates to user interfaces that present existing private jet segments. This shared flight marketplace makes private jet travel accessible to users that would otherwise not travel on private jets due to the high cost for chartering an entire private jet flight.

The shared flight marketplace differs from traditional flight reservation systems (e.g., commercial airline systems), for example, because the shared flight marketplace enables each user to individually schedule a new flight and make seats on the new flight available to other users. The shared flight marketplace also differs from traditional flight reservation systems in that it is a user-centric platform that enables users to create conditional flights that are scheduled, but not actually confirmed, unless a specified number of the available seats on that flight are claimed by other users (e.g., who may not be known by the user creating the flight). This ability to conditionally create a flight that is only confirmed after a specified number of other seats have been claimed by other users is an unconventional feature that is not provided by traditional flight reservation systems. As the shared flight marketplace allows clients to create private jet segments and claim spots on private jet segments, the amount of supply and demand for seats on private jets for various routes can change frequently. To manage the supply of spots on private jet segment for the various routes such that clients are encouraged to claim spots on existing private jet segments when appropriate and to create new client-initiated private jet segments when appropriate, the amounts required by to be submitted by clients to create a new private jet segment and/or the amounts required to claim spots on existing private jet segments can be adjusted in response to changes in the availability of spots on the private jet segments and/or changes in the amount of interest in private jet segments shown by clients. Given the speed at which the supply and demand changes, the number of users continually taking actions that affect the supply and demand, and the number of factors used to determine the required amounts for claiming spots on the available private jets, robust techniques of determining and modifying the amounts is required to ensure the right amount of supply of private jet spots are made available to the clients.

In some situations, the shared flight marketplace can also facilitate efficient exchange of information among the users. For example, the because of the interconnection of users by way of the shared flight marketplace, and the capabilities of the computer system used to implement the shared flight marketplace, and the continuous tracking of available aircraft, private jet flights that are created by one user can immediately be made available to other users within the shared flight marketplace (e.g., without requiring a sourcing delay during which an aircraft is sourced). As such, the shared flight marketplace decreases the delay between flight creation by a creator and flight notification/availability to other users.

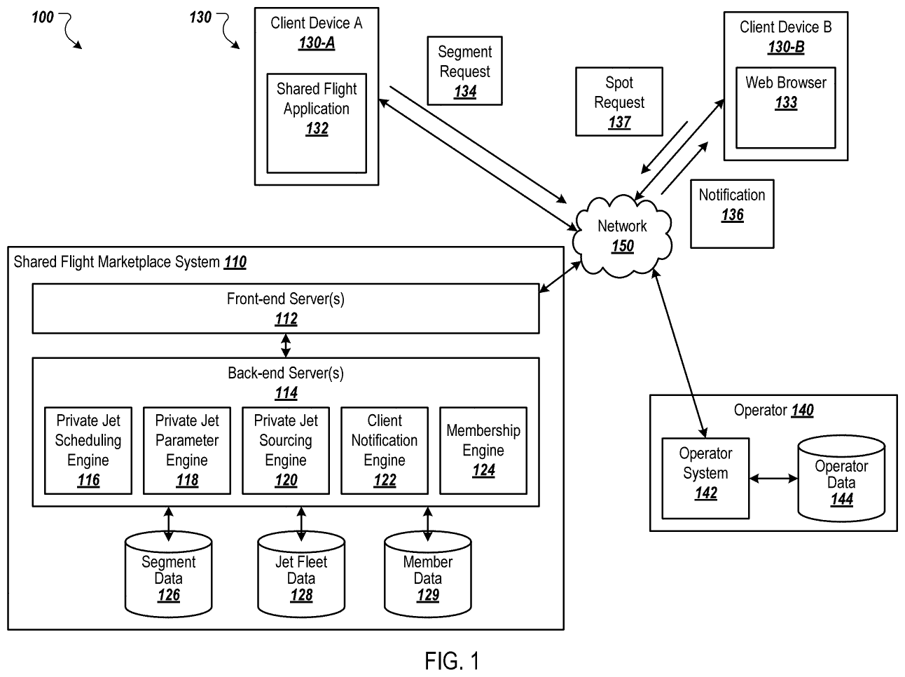

FIG. 1 is a block diagram of an example environment 100 in which a shared flight marketplace system 110 provides a shared flight marketplace in which clients can arrange private jet travel, e.g., by creating private jet segments and claiming spots on existing private jet segments. The example environment 100 includes a network 150, such as a local area network (LAN), a wide area network (WAN), the Internet, a mobile network, or a combination thereof. The network 150 connects client devices 130 (e.g., client device A 130-A and client device B 130-B) of clients, the shared flight marketplace system 110, operator systems 142 of operators 140, and publisher systems 162 of publishers 160. The example environment 100 may include many different client devices 130, operators 140, and publishers 160.

The shared flight marketplace system 110, which can be operated and maintained by a shared private jet service provider, provides a shared flight marketplace that allows clients to arrange transportation on private jet segments. The shared flight marketplace can be implemented as a network-based (e.g., online) marketplace in which clients can view, create, and claim spots on private jet segments. Clients can participate in the shared flight marketplace using client devices 130. A client device 130 is an electronic device that is capable of requesting and receiving resources over the network 150. Example client devices 130 include personal computers, mobile communication devices (e.g., Smartphones), tablet devices, and other devices that can send and receive data over the network 150.

A client can participate in the shared flight marketplace using a client-side shared flight application 132 that is executed on the client device 130-A of the client and that provides access to the shared flight marketplace. For example, a client can view segments, create and manage segments, claim spots on segments, manage other travel arrangements with the shared flight marketplace system 110, manage their profile, and/or perform other appropriate tasks related to the shared flight marketplace using the shared flight application 132. The shared flight application 132 can transmit data to, and receive data from, the shared flight marketplace system 110 over the network 150. The shared flight application 132 can be implemented as a native application developed for a particular platform or a particular device or another appropriate type of application. The shared flight application 132 can be executed by the client device 130. The shared flight application 132 can present and detect user interactions with various interfaces that allow the client to initiate segments, view segments, and/or claim spots on segments.

In some implementations, a client can participate in the shared flight marketplace using a web browser 133 executing on a client device 130-B. For example, the shared flight marketplace system 110 can provide, to the web browser 133, web pages (and/or web applications) that include user interfaces that enable clients to view segments, create and manage segments, claim spots on segments, manage other travel arrangements with the shared flight marketplace system 110, manage their profile, and/or perform other appropriate tasks related to the shared flight marketplace.

In some implementations, the shared flight marketplace system 110 includes multiple platforms (e.g., multiple servers each dedicated to a different platform) or multiple entry points that enable clients to participate in the shared flight marketplace. For example, the shared flight marketplace system 110 can include a first platform (e.g., one or more mobile application servers) that enable participation in the shared flight marketplace using the shared flight application 132 and a second platform (e.g., one or more web servers) that enables participation in the shared flight marketplace using the web browser 133.

The shared flight marketplace system 110 can also enable clients access to the shared flight marketplace through third party systems, such as the publisher systems 162 of the third party publishers 160. For example, the shared flight marketplace system can provide application programming interfaces (APIs) that enable third party publishers to publish private jet segments that are available through the shared flight marketplace and enable clients to create private jet segments and/or claims spots on shared flight segments through the third party publisher's publications (e.g., through their native applications or web interfaces). In a particular example, a travel company that enables people to book travel arrangements can publish details of private jet segments of the shared flight marketplace. The travel company's publication(s) can present the details of one or more private jet segments in response to a search for flights that match the attributes of the private jet segments. For example, the travel company's publication(s) can present the details of a private jet segment as one of multiple flight options, including flight options from commercial airlines or other providers. The travel company's publication(s) can also enable the users to claim spots on the segments. This provides another entry point into the shared flight marketplace, in addition to the shared flight application 132 and web interfaces provided by the shared flight marketplace system 110, giving users more flexibility and more options for booking air travel.

The shared private jet service provider can provide, in the shared flight marketplace, scheduled private jet segments (e.g., scheduled shuttles) between origins and destinations using a client membership model in which clients (e.g., members of the segment service provided by the segment service provider) provide a membership submission (e.g., payment) to be eligible to claim spots on the segments. The shared private jet service provider can also allow non-members to claim spots on the scheduled segments, e.g., for a required submission per spot, and/or to claim spots on other types of segments. In some situations, the required amount will vary based on the membership status of each user. For example, a non-member may be required to pay more for a spot on a particular segment than a member does. Furthermore, different membership tiers may be provided different pricing and/or different perks.

The shared flight marketplace also enables the clients (e.g., members and non-members) to create segments with custom attributes (e.g., custom departure date, origin, destination, and/or type of jet). For example, the shared flight marketplace can enable the clients to create custom shuttles between locations specified by the shared private jet service provider (e.g., along routes for which the segment service provider provides scheduled segments). The shared flight marketplace can also enable the clients to create charters (e.g., private and/or shared) between locations freely specified by the client (e.g., along routes that the segment service provider does not provide scheduled segments).

In some implementations, the shared flight marketplace can require a creator of a custom shuttle to claim at least a minimum number of spots on the shuttle. For example, a creator may be required to submit an amount for four seats on an aircraft that includes eight seats. The shared flight marketplace can then make the other four seats available to other clients, e.g., by publishing the custom shuttle on interfaces of the shared flight application and/or sending push notifications to the clients. The creator can also offer some of the four seats claimed by the creator to other clients in exchange for a rebate, internal credit (e.g., renewable token or free spot on another segment), money, or other appropriate item of value. These offered spots can be made available to the other clients in a similar manner as the other four seats. The shared flight marketplace can provide the rebate or other item of value to the creator for each of the offered spots that another client claims.

In some implementations, the creator can specify the amount for each offered spot. This provides flexibility to the creator so that the creator can specify lower amounts to increase the likelihood of another client claiming a spot or specify higher amounts to increase the amount of rebate or other item of value for the spots. The creator can also specify different amounts for different clients. For example, the creator can specify a first amount for clients that the creator knows or has flown with in the past and a second amount (e.g., higher than the first amount) for other clients. In this example, the shared flight marketplace system 110 can maintain, for each given client, a list of other clients that the given client knows, similar to a friend list of a social network.

A client-initiated private charter is a private jet segment between two locations freely specified by the client and for which the creator has not made any spots available for other clients. For example, the creator can create a private charter segment for the creator and optionally others invited by the creator. A client-initiated shared charter is a private jet segment between two locations freely specified by the client and for which the creator has made at least one spot available for other clients to claim. For example, a creator may want to create a private jet segment between locations that are not specified by the shared private jet service provider (e.g., a route for which the shared private jet service provider does not provide scheduled segments) but does not want to be responsible for the full amount required to be submitted to create the charter segment. The creator can create a shared charter segment (e.g., by converting a created private charter segment to a shared charter segment) and make at least one spot available for other clients. For example, the creator an offer some of the spots on the charter in exchange for a rebate, internal credit (e.g., renewable token or free spot on another segment), money, or other appropriate item of value. As described below, push notifications that notify other clients of the shared charter segment can be provided to other clients, e.g., clients that have been identified as potentially being interested in the route. The shared flight marketplace can provide the rebate or other item of value to the creator for each of the offered spots that another client claims. Similar to custom shuttles, the creators of shared charters can specify the amount of the rebate or other item of value.

The shared flight marketplace can also enable the clients to create conditional shuttles, which are also referred to as crowdsourced shuttles. A conditional shuttle is a client-initiated shuttle that is created by multiple creators, e.g., via crowdsourcing. For example, a first creator can create a conditional shuttle that is contingent on at least a specified number of spots being claimed by one or more other co-creators before the shuttle can be confirmed. The shared flight marketplace may require that at least a specified minimum number of spots are claimed before confirming a conditional shuttle having the features (e.g., route, type of private jet, departure time and date, and so on) of the conditional shuttle. The ability to initiate a conditional shuttle enables a client to create a private jet segment without being responsible for (e.g., have to submit a required amount for) all of the minimum number of spots. Instead, the shared private jet service provider can notify other clients that the conditional shuttle is available and allow other clients an opportunity to claim a spot on the conditional shuttle. A client that claims a spot on a conditional shuttle become a co-creator of the conditional shuttle. If the clients claim at least the minimum number of spots on the conditional shuttle, the shared flight marketplace convert the crowdsourced shuttle to a confirmed crowdsourced shuttle that will be scheduled for the clients that claimed a spot on the conditional shuttle. If the conditional shuttle includes additional spots above the minimum number that have not been claimed, the shared flight marketplace can make those spots available to other clients as well and notify the clients of the available spots on the conditional shuttle (e.g., using push notifications).

The segment management system 110 includes one or more front-end servers 112 and one or more back-end servers 114. The front-end servers 112 can transmit data to, and receive data from the client devices 130, e.g., client device A 130-A and client device B 130-B, and operator systems 142 of operators 140 over the network 150. For example, the front-end servers 112 can provide, to the shared flight application 132 of the client device 130-A of a client, interfaces or data for presentation with the interfaces. The front-end servers 112 can also receive data specifying interactions with the interfaces of the shared flight application 132, such as attributes of a private jet segment created by the client. The front-end servers 112 can update the interfaces, provide new interfaces, and/or update the data presented by the interfaces based on user interactions with the shared flight application 132. Similarly, the front-end servers 112 can update interfaces, provide new interfaces, and/or update the data presented by interfaces at the web browser 133 of the client device 130-B.

The front-end servers 112 can communicate with the shared flight applications 132 executing on client devices 130 using a messaging protocol. For example, the shared flight applications 132 can transmit, to the front-end servers 112, messages that specify spots being claimed by clients, attributes of client-initiated segments created by the clients, preferences specified by the clients (e.g., preferred locations for which the clients want to receive notifications), and/or other appropriate data. The front-end servers 112 can transmit, to segment applications 132, messages that specify the status of existing segments, parameters of existing segments (e.g., a spot claiming requirement)

The front-end servers 112 can also communicate with the back-end servers 114. For example, the front-end servers 112 can identify data that is to be processed by the back-end servers 114, e.g., data specifying attributes of a client-initiated private jet segment, and provide the data to the back-end servers 114. The front-end servers 112 can also receive, from the back-end servers 114, data for a particular client and transmit the data to the client device 130 of the particular client over the network 150.

The back-end servers 114 include a private jet scheduling engine 116, a private jet parameter engine 118, a private jet sourcing engine 120, a client notification engine 122, a membership engine 124, and a rating engine 125. As used herein, the term engine refers to one or more data processing apparatus that perform a set of tasks. The private jet scheduling engine 116 manages the creation, confirmation, and/or cancellation of private segments based on data submissions (e.g., requests) received from client devices 130 of clients participating in the shared flight marketplace. The private jet scheduling engine 116 also manages the spots on existing private jet segments, e.g., adding a client to a private jet segment based on a data submission that specifies that the client is claiming a spot on the private jet segment.

The private jet scheduling engine 116 can receive data specifying attributes of a new private jet segment initiated by a client and create the segment within the shared flight marketplace. For example, a client that uses a client device A 130-A can interact with interfaces of the shared flight application 132 to initiate a private jet segment (e.g., a client-initiated private jet shuttle) and specify attributes of the segment. The attributes can include a departure geographic identifier (e.g., an origin city or airport code), a destination geographic identifier (e.g., a destination city or airport code), a departure date (which can include a date and/or time) at which the private jet segment will depart from the origin, a type of jet (e.g., light, midsize, heavy, propeller, rotorcraft, etc.), a number of spots being claimed by the client, and/or other appropriate attributes.

The shared flight application 132 can generate a segment request 134 (e.g., in the form of a message) and cause the client device A 130-A to transmit the segment request 134 to the segment management system 110 over the network 150, e.g., using one or more messages. The segment request 134 can include one or more of the client-specified attributes. In some implementations, the segment request 134 can include all of the attributes. For example, the shared flight application 132 can cause the client device A 130-A to transmit the segment request 134 after all of the appropriate attributes have been obtained from the client. As described in more detail below, the shared flight application 132 can prompt the client for the attributes using multiple interfaces.

In some implementations, the segment request 134 includes only a portion of the attributes (e.g., less than all of the attributes required by the shared flight marketplace). For example, the private jet scheduling engine 116 can cause the shared flight application 132 to prompt the client for additional attributes or other information based on initial attributes received in the segment request 134. In a particular example, the segment request 134 can include the departure geographic identifier, destination geographic identifier, and departure date. The private jet scheduling engine 116 can receive these attributes, identify what types of jets are available for travel from the origin to the destination, and provide data specifying the available types of jets to the client device A 130-A for presentation by the shared flight application 132 to the client. The client can then select from the available types of private jets and the shared flight application 132 can cause the client device A to transmit data specifying the selected type of private jet to the shared flight marketplace system 110.

The private jet scheduling engine 116 can receive the segment request 134, create the appropriate type of segment within the segment management system 110 based on the data and the attributes received from the client device A 130-A, and make the segment available to other clients in the shared flight marketplace if appropriate. The private jet scheduling engine 116 can make the segment available in the shared flight marketplace, e.g., in the shared flight application 132, immediately when the segment is created. For example, once the segment is created, the private jet scheduling engine 116 can update the various interfaces of the shared flight application 132 (and/or web pages), push data that specifies the attributes of the segment to the client devices 130, and/or send data that specifies the attributes of the segment to the segment application 132 when the segment application 132 is opened at a client device 130.

The private jet scheduling engine 116 can also store the data for the created segment in a segment data storage unit 126. The segment data storage unit 126 can include one or more databases (or other appropriate data storage structures) stored in one or more non-transitory data storage media (e.g., hard drive(s), flash memory, etc.). Although the above example was described in terms of a client creating a client-initiated private jet segment using the shared flight application 132, a client can create a client-initiated private jet segment using the web browser 133 in the same or a similar manner.

The segment data storage unit 126 can store data for each segment that is provided by the shared flight service provider, e.g., each segment created within the shared flight marketplace. For example, the segment data storage unit 126 can store data for each scheduled private jet segment scheduled by the shared flight service provider and each client-initiated private jet segment created by a client. The segment data storage unit 126 can store data for previously operated segments, segments scheduled by the shared flight service provider that have not yet departed, and/or client-initiated segments that have not yet departed.

In some implementations, the stored data can include, for each private jet segment, one or more of a type of aircraft selected for the segment, a departure date and/or time for the segment, geographic identifiers for the origin and destination of the segment, a number of spots on the segment, a number of spots claimed on the segment, the operator that will provide the selected aircraft, a required submission provided by clients to claim a spot on the segment, whether the segment is a scheduled segment that was scheduled by the shared flight service provider or a client-initiated segment, identifiers for each client that claimed a spot on the segment, identifiers for clients (and a number of clients) that actually boarded the segment if the segment has departed, and/or other appropriate data about the segment. For client-initiated segments, the data can also include an identifier of the creator that created the segment, whether the segment is a client-initiated private jet shuttle, a conditional segment, a client-initiated private charter segment, a client-initiated shared charter segment, and/or other appropriate data for client-initiated segments.

The client notification engine 122 can notify other clients of the client-initiated private jet segment created in the shared flight marketplace if appropriate. For example, if the client-initiated private jet segment is a private charter or a shuttle for which the creator claimed all of the spots, the client notification engine 122 may not notify other clients. If the client-initiated private jet segment includes one or more available spots that other clients can claim, the client notification engine 122 can notify at least a portion of the other clients.

In some implementations, clients can view the various segments between two locations (e.g., from an origin location to a destination location) using an interface of the shared flight application 132, the web browser 133, or a third party system. For example, the shared flight application 132 can present segment indicators for existing segments between the two locations using a calendar interface. The calendar interface can include, for each date, zero or more segment indicators for each existing segment between the two locations on that date. In this example, each segment indicator can be a dot presented adjacent to (e.g., under, above, to one side, or around) the date in the calendar. The segment indicators can include other visual indicators, such as lines, squares, triangles, airplane symbols, or other appropriate indicators. In another example, the calendar interface can include, for each date that includes at least one available spot on an existing segment between the two locations on that date, a line under the date.

For example, after a segment is created, a segment indicator (e.g., dot, line, or other appropriate indicator) can be presented under the departure date for the segment to represent the created segment. If a different client is viewing the calendar interface for flights from the same origin and to the same destination as the created segment, the client can see the dot (or line) for the created segment and interact with the dot, the date, or the line (e.g., by selecting the dot, date, or line) to view more information about the created segment and/or claim a spot on the created segment. The segment indicators can include other visual indicators, such as squares, triangles, airplane symbols, or other appropriate indicators.

The visual features of the segment indicators can be used to represent the status of the segments. In some implementations, the color of a segment indicator represents the status of the segment. For example, a first color can be used to represent a full segment, a second color different from the first color can be used to represent a confirmed segment that has one or more available spots, and a third color different from the first and second colors can be used to represent a conditional segment that has not yet been confirmed. In another example, different shading of a same color, different hatching, and/or different sizes of segment indicators can be used to represent the status of the segments. In yet another example, motion of the visual indicators can be used to represent the status of the segments, e.g., a segment with available spots can be animated to rotate or expand and contract, while full segments may not move.

The segment management system 110 and/or the shared flight application 132 can visually update the segment indicators for the segments in response to a change in status of the segments. For example, if a conditional segment is confirmed, the shared flight marketplace system 110 can provide data specifying the updated status of the segment to the client devices 130. In a particular example, if a client is viewing a calendar interface for segments from an origin to a destination and the status of one of the segments changes, the segment management system 110 can provide data specifying the updated status of the segment to the client device 130 of the client. In response to receiving the data, the shared flight application 132 can update the visual feature(s) of the segment indicator for the segment to represent the updated status, e.g., by changing the color of the segment indicator for a segment. In another example, if the last spot has been claimed on the only segment that had availability for a given date, the line under the date can be removed or hidden to indicate that there are no available spots on segments for that date.

In some implementations, the client notification engine 122 notifies clients using push segment notifications 136. For example, the client notification engine 122 can send messages (e.g., within the shared flight application 132, via text messaging, and/or via e-mail) to the clients to notify the clients of the created segment. The messages can include code (e.g., an active link) that navigates directly to an application page within the shared flight application 132 (or to a web page in a web interface) to claim a spot on the segment. The shared flight application 132 can present notifications for segments using a dedicated interface. For example, the client can view notifications for segments by navigating to the interface. The notification can cause the client device 130 to present visual information (e.g., information about the segment), generate audio information (e.g., a sound that alerts the client), and/or create a tactile sensation (e.g., a vibration of the client device 130). In some implementations, the client notification engine 122 transmits the notifications 136 to clients that are likely to be interested in the created segment.

The client notification engine 122 can select clients to notify about the availability of a client-initiated private jet segment (or a shared flight service provider scheduled segment) and enable the clients to claim a spot on the segment. For example, rather than notify all clients of the service about each client-initiated segment, the client notification engine 122 can select a subset of the clients to provide the notification. The client notification engine 122 can select the clients for a given private jet segment based one or more factors, such as, for each client, a set of client-specified location identifiers specified by the clients as frequent locations for which the client requests to receive notifications, locations that the client has spent at least a threshold amount of time (or was located at least a threshold number of times), the number of times the client has selected to view segment information for (or searched for) routes that have a same geographic identifier as the private jet segment, the number of times the client has claimed a spot on a segment between the same origin and destination as the private jet segment, and/or other appropriate factors.

A client, e.g., the client associated with (e.g., logged into the shared flight application 132 on) the client device B 130-B, can request a spot on a client-initiated segment using the web browser 133 (or a shared flight application 132 installed on the client device 130-B). For example, the client can view more information about segments by interacting with (e.g., selecting) a segment indicator or a date in a calendar interface of a web application of a web page presented by the web browser 133. In response to detecting the interaction, the web application can present an interface that shows information about the segment(s) and enables the client to claim a spot on the segment(s). In another example, the client can select a link in a push notification or a private jet segment presented in an interface presented in response to the client interacting with a push notification.

The shared flight application 132 can then generate a request for a spot request 137 and transmit the spot request 137 to the segment management system 110. The spot request 137 can include data specifying the client that submitted the request and an identifier of the segment on which the client is requesting a spot.

The private jet scheduling engine 116 can receive the request for the segment spot 137 and determine whether there is still a spot available on the segment. For example, there may not be a spot available if other clients have claimed all of the available spots. If there is still a spot available on the segment, the private jet scheduling engine 116 can add the client that submitted the spot request 137 to the segment. If not, the private jet scheduling engine 116 can send a notification to the client that the segment is no longer available, e.g., on an interface of the shared flight application 132 or an interface of a web application of a web page presented by the web browser 133.

The private jet parameter engine 118 can determine and adjust parameters for each of the private jet segments. The parameters for a private jet segment can include parameters that restrict access to spots on the private jet segment. For example, the parameters for a private jet segment that has not yet been created can include one or more creation requirements for a client to create the new private jet segment. The creation requirements can include an amount (e.g., in the form of currency, internal credits, or other item of value) that must be submitted by the creator for the private jet segment to be created.

The amount of the creation requirement for a given private jet segment on a given route can be based on attributes for the given segment and/or the historical data for previous segments that have attributes matching the set of attributes for the given private jet segment. These attributes can include the type of private jet segment (e.g., shuttle, charter, conditional, etc.), the departure day of the week, the departure date, the arrival date, the departure port, the arrival port, the type of jet, and/or other appropriate attributes of a private jet segment. The amount can also be based on factors that can change frequently over time, such as the number of available spots on other segments for the same route as the given private jet segment (e.g., with the same departure date as the given private jet segment or with a departure date within a threshold number of days of the departure date of the given private jet segment) and/or the number of other clients requesting private jet segments for the same route as the given private jet segment.

The creation requirements for a private jet segment that has not yet been created can also include a minimum number of spots required to be claimed by the creator in order to create the private jet segment. The private jet parameter engine 118 can determine the minimum number of spots based on the total number of spots on the jet (or type of jet) selected for the private jet segment, historical data that represents the number of spots claimed by other clients on the same route and/or for a same departure time period (e.g., day of the month, day of the week, month of the year, time of day, and/or other appropriate time periods), and/or other appropriate information. For example, if the historical data indicates that, on average, one other spot is claimed on private jet segments for this route for previous segments having the same (or similar) jets and the same (or similar) departure time periods, the private jet parameter engine 118 can determine the minimum number of spots such that the cost of the private jet segment will be covered by the minimum number of spots claimed by the creator or the minimum number of spots plus one additional spot.

The parameters for an existing private jet segment can include a spot claiming requirement. The spot claiming requirement can be amount required to be submitted for each spot claimed by a finder. The spot claiming requirement can include an amount (e.g., in the form of currency, internal credits, or other item of value) that must be submitted by the finder to reserve the spot.

The amount of the spot claiming requirement for a spot on a given private jet segment can be based on various factors. For example, the amount can be based on a baseline amount that is based on attributes for the given private jet segment and/or the historical data for previous segments that have attributes matching the set of attributes for the given candidate segment. These attributes can include the type of private jet segment, the departure day of the week, the departure date, the arrival date, the departure port, the arrival port, the type of jet, and/or other appropriate attributes of a private jet segment. The amount can also be based on factors that can change frequently over time, such as the number of available spots on other segments for the same route as the given private jet segment (e.g., with the same departure date as the given private jet segment or with a departure date within a threshold number of days of the departure date of the given private jet segment), the number of other clients requesting private jet segments for the same route as the given private jet segment, the number of clients that have added the private jet segment to a segment list (e.g., wish list), an aggregate user rating of the route and/or operator that will operate the jet for the private jet segment, and/or other appropriate factors.

The amount of data that is required to be considered during these dynamic changes to the spot claiming requirement for each spot and the creation requirement for each date for each route, and the fact that this data is ever changing, prevents a person (or even a team of people) from being able to continually update the required amount that is made available to various clients for countless possible travel routes (e.g., between various combinations of origins and destinations). For example, in the amount of time it would take a person to revise a single spot claiming requirement or a single creation requirement for a single travel route and single jet type, the combination of factors considered in making the revision likely would have changed, thereby rendering the human created required amount outdated. Manual computation of the updated per-spot claiming requirement would also prevent the real-time interactivity that is provided by the system described herein. Thus, the use of a computer system to implement the techniques described herein is not simply to improve an existing process, but rather the use of the computer system is required to provide the capabilities described herein.

The private jet parameter engine 118 can adjust the parameter(s) for private jet segments and routes in response to the modifications in the availability of spots on the private jet segments and the routes. For example, when a client device 130 transmits a data submission (e.g., a message) that modifies an availability of spots on a private jet segment, the private jet parameter engine 118 can determine an effect of the modification on the availability of various spots on private jet segments between various geographic locations. The private jet parameter engine 118 can also modify one or more parameters that restrict access to the other spots based on the effect of the modification. For example, the private jet parameter can modify the creation requirement and/or the spot claiming requirement for one or more other private jet segments based on the effect of the modification.

In a particular example, if a client has claimed a spot on a given private jet segment on a given route, the total number of available spots on the given private jet segment and on the given route has decreased (assuming no new jet segment was added for the given route around the same time). In response to this decrease in the number of available spots, the private jet parameter engine 118 can decrease the creation requirement for a client to create a new private jet segment on the given route to counteract the decrease in the number of available spots. Similarly, to increase the likelihood that a client will create a new private segment on the given route, the private jet parameter engine 118 can increase the spot claiming requirement for any remaining available spots on the given private jet segment and other private jet segments on the given route (e.g., private jet segments that departs within a threshold number of days of the departure date of the given private jet segment).

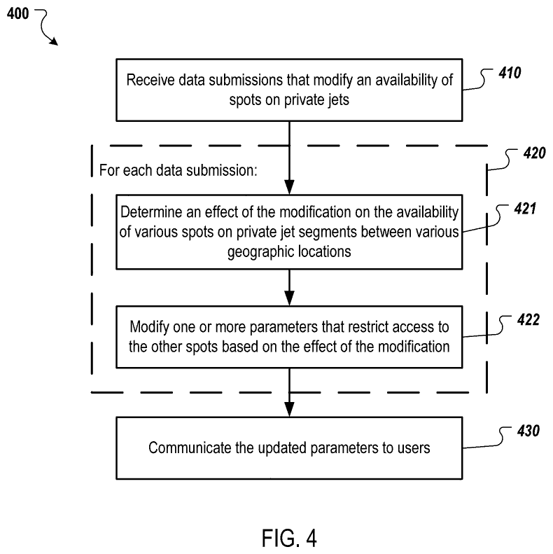

In another example, if a client creates a new private jet segment that includes at least one available spot on a given route, the total number of available spots on the given route has increased (assuming no spots on the route were claimed around the same time). In response to this increase in the number of available spots, the private jet parameter engine 118 can increase the creation requirement for clients to create new private jet segments on the given route so that clients are more likely to claim available spots on the given route. Similarly, the private jet parameter engine 118 can reduce the spot claiming requirement for the available spots on private jet segments for the given route. An example process for modifying parameters of private jet segments based on modifications to the availability of spots on segments is illustrated in FIG. 4 and described below.

The aircraft used for the private jet segments can be provided by and/or operated by the shared flight service provider and/or third party operators that are different from the shared flight service provider and different from the clients. An example operator may operate jets as part of a private jet charter business ran by the operator or for other purposes. The operator may also make some jets available for use by the shared flight service provider and operate these jets, e.g., in response to requests for a jet initiated by the shared service provider service provider.

The private jet sourcing engine 120 can select a jet for a private jet segment from among a candidate fleet that includes an owner private aircraft fleet owned and/or operated by the shared flight service provider and a third party private jet fleet owned and/or operated by one or more third parties. Information about the jets of each fleet can be stored in a jet fleet data storage unit 128. The information can include, for each jet, an identifier that identifies the owner (e.g., the shared flight service provider, the third party, etc.), the number of spots on the jet, flight range, flight time rates, amounts for particular routes or segments, amenities on the jet, and/or other appropriate data).

The private jet sourcing engine 120 can select the jet for a particular private jet segment based on the characteristics of the segment and the information about each jet in the fleets. For example, the private jet sourcing engine 120 can identify a subset of the jets that meet the characteristics required by the segment. In a particular example, if a client created a private jet segment and specifies a heavy jet with a particular amenity, the private jet sourcing engine 120 can filter jets that are not classified as heavy jets and that do not have the particular amenity from the candidate fleet. The private jet sourcing engine 120 can then select a jet from the filtered candidate based on the information about the jets (e.g., their relative estimated costs based on flight time rates and estimated flight time of the segment), the location of the jets (e.g., based on an estimated cost of moving the jets to the departure location for the segment), quality of service of the jet or third party (e.g., based on client reviews) and/or other appropriate information.

The private jet sourcing engine 120 can interact with the operator systems 142 of the third party operators 140 to obtain information about the jets owned by the third parties. For example, when the private jet scheduling engine 116 creates a private jet segment (e.g., a shared flight service provider scheduled segment or a client-initiated segment), the sourcing engine 120 can interact with the operator systems 142 to identify a jet of the same type as the created segment that can be used for the segment. For example, the private jet sourcing engine 120 can submit a request to each operator system 142 for a jet of the type of the created segment. In response to receiving a request, the operator systems 142 can obtain information regarding available jets from their respective operator segment data storage units 144 and provide, to the private jet sourcing engine 120, the information about any available jets that the operator 140 is willing to operate for the created segment (e.g., number of spots on the jet, rates for particular segments, range, etc.).

In some implementations, the front-end servers 112 of the segment management system 110 communicate with the operators systems 142 using application programming interfaces (APIs). The use of the APIs require computational power to communicate data. To reduce the amount of computational power used by the APIs, the shared flight marketplace system 110 can identify a subset (e.g., less than all) of operators 140 for a particular segment and provide the request to only the operators in the subset. The private jet sourcing engine 120 can identify the subset of operators based on the departure geographic identifier (e.g., identify operators that operate jets in the geographic area from which the segment will depart), previous segments provided by the operators (e.g., previously provided a jet for the same origin and destination), types of jets that the operator operates, and/or other appropriate criteria. In some implementations, communications with operators can be carried out using other communications means (e.g., phone). When the segment has been confirmed by the operator 140, the selected aircraft will be deployed to the origin at an appropriate time so that the selected aircraft will be available for any clients that have obtained spots (e.g., seats) on the created segment.

In some implementations, the shared flight service provider also owns and/or operates its own fleet of private jets. In this example, the private jet sourcing engine 120 can select a jet from among a candidate fleet that includes the owner private jet fleet owned and/or operated by the shared flight service provider and third party private jets owned by one or more third parties. The ability to select a jet from a provider owned/operated fleet of private jets can help facilitate the immediate (e.g., within a specified amount of time or with only computer processing delay) release of a created shared flight to other users.

The membership engine 124 manages the membership of clients of the shared flight service provider. For example, the membership engine 124 can receive and process requests from potential clients to become members of the shared flight service provided by the shared flight service provider. As described above, a client can also participate in the shared flight marketplace without being a member.

The membership engine 124 can also maintain membership data for each client that becomes a member and/or for non-member clients. The membership data can include a profile for each client. The profile for a client can include the name of the client, contact information for the client (e.g., an address and/or phone number), payment information, and/or other appropriate information related to the client. The profile for a client can also include a geographic identifier (e.g., name of a city, state, region, country, or other geographic identifier) for a primary geographic location for the client. The primary geographic location for the client can be a location of primary residence. For example, a client may have multiple residences, but may be requested to provide a geographic location (e.g., address) for a primary residence.

The membership data for a client can also include data identifying private jet segments on which the client claimed a spot, if the client has claimed a spot on at least one segment. For example, a new client may have not yet claimed a spot or traveled on any segments. The membership data for each client can include, for each route, a number of times the client claimed a spot on a segment on the route.

The membership engine 124 can store the membership data for each client in a membership data storage unit 129. The membership data storage unit 129 can include one or more databases (or other appropriate data storage structures) stored in one or more non-transitory data storage media (e.g., hard drive(s), flash memory, etc.).

The rating engine 125 enables clients to provide feedback on private jet segments on which the clients have traveled. For example, after a segment is completed, the rating engine 125 can prompt the client to provide feedback via the shared flight application 132, a web form in a web page presented by the web browser 133, e-mail, over the phone, or another appropriate way. The feedback can include numerical ratings for the operator 140 that operated the segment, the airports (e.g., the route itself), the private jet (or type of private jet or make and/or model of private jet) used for the segment, and/or other appropriate aspects of a private jet segment.

The rating engine 125 can determine an aggregate rating for an existing (e.g., not yet departed) private jet segment based on the individual ratings for the various aspects of the private jet segment. For example, the aggregate rating for a private jet segment can be based on a combination of the ratings received for the operator that will be operating the segment (e.g., ratings for the operator over multiple segments on multiple routes), the airports or route, the private jet (or type or make and/or model), and/or other appropriate ratings. In a particular example, the aggregate rating is equal to, or proportional to, an average of the individual ratings.

In some implementations, the private jet parameter engine 118 determines the spot claiming requirement and/or the creation requirement for private jet segments based on the aggregate ratings. For example, a higher rating may correspond to better service and/or a better travel experience. In this example, the amount of the spot claiming requirement and/or creation requirement can be higher for private jet segments that have higher ratings. In this way, clients that want better service can obtain the better service by paying a higher amount for the flight. Similarly, clients that would prefer a more inexpensive flight can create or find a segment with a lower aggregate rating. This provides additional flexibility and options for the clients of the shared flight marketplace.

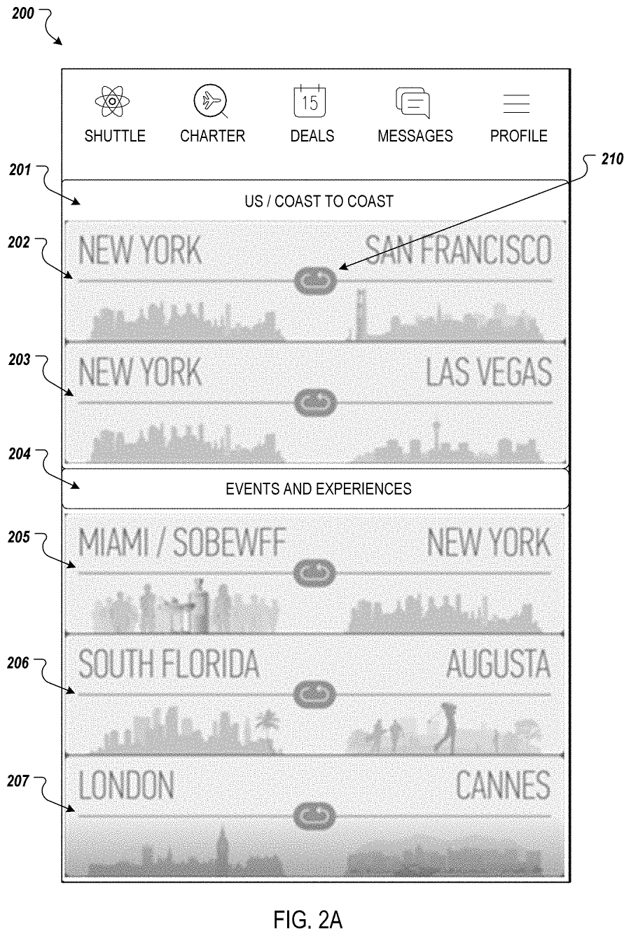

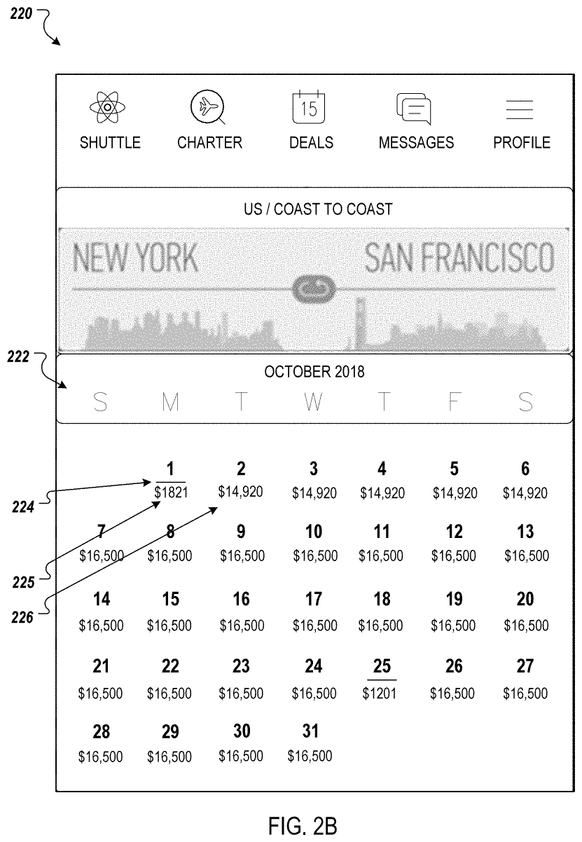

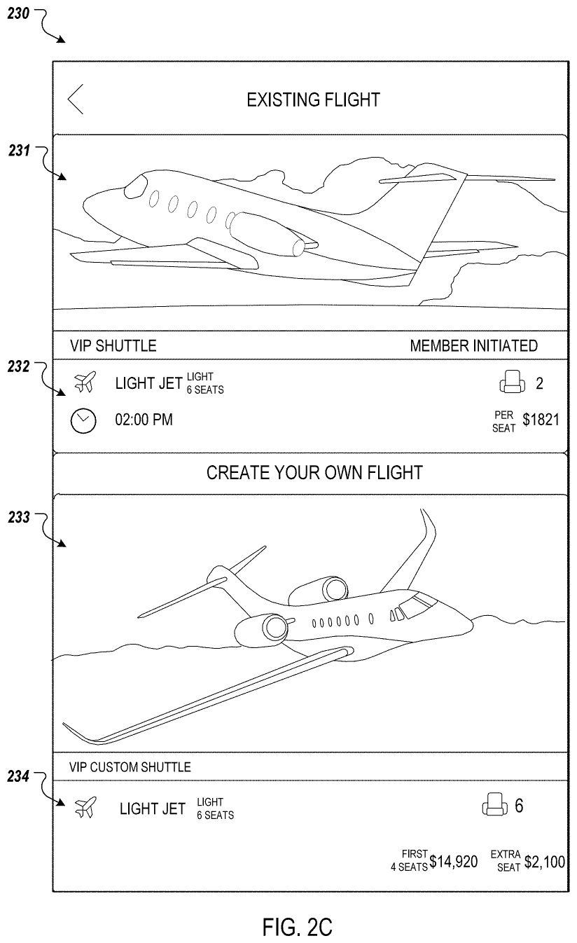

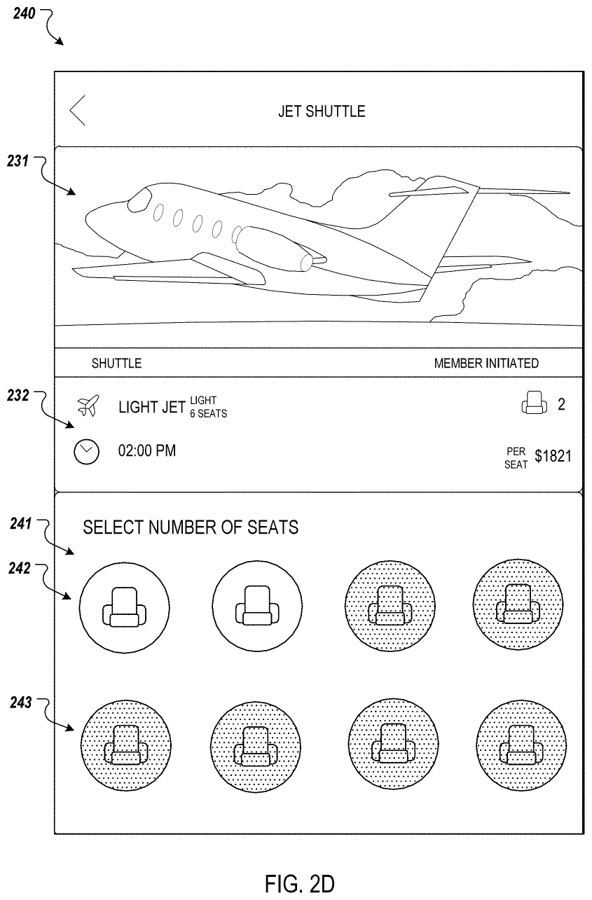

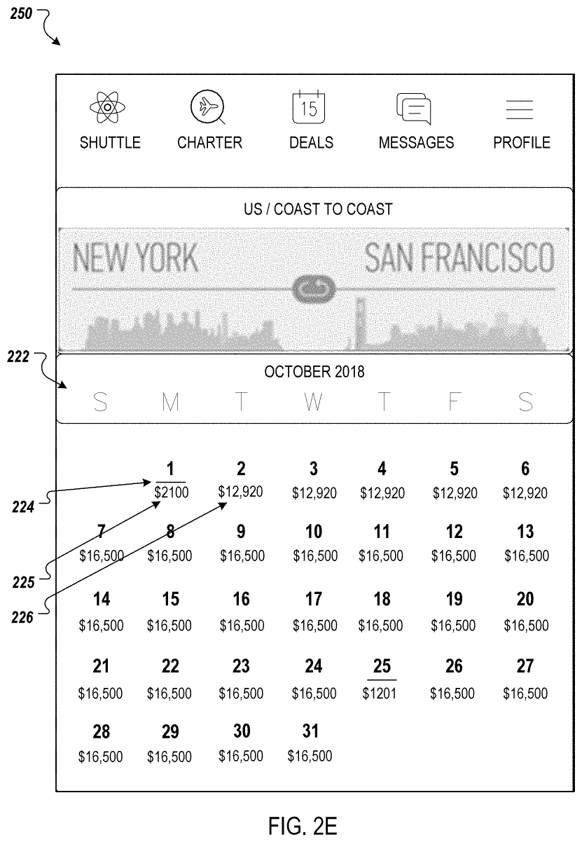

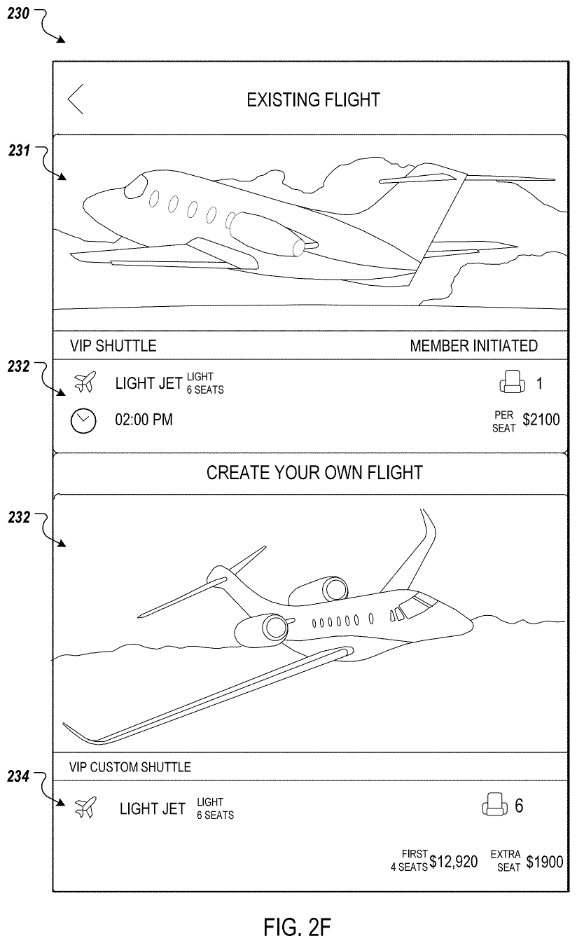

FIGS. 2A-2F are screenshots of example graphical interfaces of a shared flight marketplace that enable clients to participate in the shared flight marketplace. For example, the graphical interfaces enable clients to create private jet segments and claim spots on private jet segments. The example graphical interfaces can be generated and/or presented by the shared flight application 132 and/or presented by web pages in the web browser 133 of FIG. 1.

FIG. 2A is a screenshot of an example route selection interface 200 that enables a client to select a route between two geographic locations (e.g., between two cities). The routes can be grouped based on various factors, e.g., geography, upcoming events, etc. In this example, a first group of routes 201 for coast-to-coast segments in the U.S. is presented near the top of the route selection interface 200. A second group of routes 204 for segments to and from geographic locations that will be hosting upcoming events is presented below the first group of routes 201. Additional groups can be presented below the second group of routes 204. A client can view the additional groups by interacting with the route selection interface, e.g., by swiping up on the route selection interface if the client device is a touch screen device.

The route selection interface 200 includes a route selection element for each route. For example, the route selection interface 200 includes a route selection element 202 for the route between New York City and San Francisco, a route selection element 203 for the route between New York City and Las Vegas, a route selection element 205 for the route between Miami and New York City, a route selection element 206 for the route between South Florida and Augusta, and a route selection element 207 for the route between London and Cannes. User interaction with a route selection element (e.g., selection of a route selection element) can cause the shared flight application 132 to present information about existing segments for the route represented by the route selection element. For example, if the shared flight application 132 detects interaction with the route selection element 202, the shared flight application 132 can present the example calendar interface 220 of FIG. 2B.

Each route selection element includes a route reversal element 210 that, when interacted with, swaps the origin and the destination of the route. For example, the location on the left of each route selection element can be the origin and the location on the right of each route selection element can be the destination. In this example, New York City is the origin and San Francisco is the destination for the route represented by the route selection element 202. If the client wants to view information about segments from San Francisco to New York City, the client can interact with the route reversal element 210 in the route selection element 202. In response, the shared flight application 132 can update the route selection element 202 to present San Francisco on the left and New York City on the right. In addition, the shared flight application 132 can present information about segments from San Francisco to New York City if the client interacts with the route selection element 202 while San Francisco is presented on the left and New York City is presented on the right.

FIG. 2B is a screenshot of an example calendar interface 220 for presenting data specifying the status of segments and required submissions for segments. The shared flight application 132 can present the calendar interface 220 in response to client interaction with the route selection element 202 for the route from New York City to San Francisco at the route selection interface 200 of FIG. 2A.

The calendar interface 220 includes a calendar 222 that presents the days within a month of the year. In this example, the calendar 222 is for October, 2018. For example, the shared flight application 132 can present a calendar 222 for the current month in response to client interaction with a route selection element. The client can then navigate to other months, e.g., by swiping left or right on the calendar 222. For example, a swipe to the right can cause the shared flight application 132 to present the previous month (e.g., September, 2018) and a swipe to the left may cause the shared flight application 132 to present the next month (e.g., November, 2018). In other examples, the calendar can present other date ranges, e.g., each week of the year, each quarter, etc.

The calendar interface 220 includes an existing segment indicator 224 for each date for which one or more existing segments in the shared flight marketplace that are scheduled to depart along the route (e.g., in this example from New York City to San Francisco) and includes at least one available spot. In this example, the existing indicator 224 is a line under the date. In other examples, the shared flight application 132 can indicate which dates have an available existing segment using other indicators, e.g., colored dots as described above, different shapes, different color text for the date than the text color for dates that do not have an existing segment, and/or using other appropriate indicators.

The status of a segment can include, for example, whether a scheduled segment exists or does not exist. In other words, when there is not a scheduled segment with available seats on a given day, the status of segments on that day can be set to “not-available,” whereas when there is a scheduled segment on that given day, the status of segments on that day can be set to “available.” For example, if the last spot on the only existing segment (or the only segment that previously had an available spot) for a date is claimed, the status of segments on that date can be updated from “not-available” to “available.” When the status of segments for a given day is set to “not-available,” the existing segment indicator 224 can be omitted (or hidden) from the calendar interface 220 for that given day, but when the status of segments for the given day is set to “available,” the existing segment indicator 224 can be presented in the calendar interface 220 for that given day. In this way, the limited display space of mobile devices (and other devices) can be more efficiently utilized to allow users to quickly identify those days on which there are available segments already scheduled.

The presentation of the existing segment indicators 224 allows a client to quickly identify each date for which an existing segment is available and for which the client can claim a spot without having to navigate to interfaces for multiple dates to determine whether spots are available on those dates. In this example, the existing segment indicators 224 indicate that there are available spots on existing segments on October 1 and October 25. If the client wants to travel on one of the dates that have an existing segment indicator 224, the client can interact with the date (e.g., select the date). In response, the segment application 132 can present the interface 230 of FIG. 2C that enables the client to view information about the existing segment(s), claim a spot on an existing segment, or create a new client-initiated private jet segment. If the client wants to travel on a different date, the client can interact with the date (e.g., select the date) to initiate a new segment for that date. In response, the segment application 132 can present an interface that enables the client to initiate a new client-initiated private jet segment with custom attributes. Such an interface can be similar to the graphical interface 230, but without presenting existing segments as there would be no existing segments for that date.

The calendar interface 220 also includes a required submission for each date. For example, the calendar interface 220 includes a required submission element 225 for October 1 and a required submission element 226 for October 2. Each required submission element indicates the amount of a required submission (e.g., payment) a client would be required to submit in order to travel on a private jet on that date. For example, each required submission element can indicate the minimum amount required to travel on a private jet on that date.

If the shared flight marketplace includes an existing private jet segment that is scheduled to depart on the date, the required submission element for the date can indicate the spot claiming requirement to claim a spot on the existing segment for that date. For example, the required submission element 225 indicates that the spot claiming requirement for October 1 is $1821 to claim a spot on an existing private jet segment for that date. If there are multiple existing segments for a date, the required submission element for the date can indicate the minimum (e.g., lowest priced) available spot for that date.

If the shared flight marketplace does not include an existing private jet segment for a date, the required submission element for the date can indicate the creation requirement for the client to create a new private jet segment for the date. For example, the required submission element 226 indicates that the creation requirement for creating a new private jet segment to depart on October 2 from New York to San Francisco is $14,920. If there are multiple types of jets that can be selected for a date, the required submission element for the data can indicate the minimum (e.g., lowest priced) jet for that date. For example, larger jets can have a higher creation requirement than smaller jets.

Presenting the required submission elements within the calendar interface 220 can encourage clients to create new segments on dates for which existing segments are not available. By presenting the creation requirements for these dates, a client can quickly assess the cost for creating a new client-initiated private jet segment or compare the cost to costs required for existing segments without having to navigate to a segment initiation interface for each date of interest to the client. Presenting the creation requirements for these dates also indicates to the client that traveling on these dates is possible even though an existing segment is not available for those dates. If the required submission was only presented for dates for which an existing segment was available, clients may be discouraged from interacting with the date and initiating a new custom private jet segment for that date.

FIG. 2C is a screenshot of an example interface 230 that presents information about private jet segments. The shared flight application 132 can present the interface 230 in response to detecting client interaction with one of the dates (or segment indicators) presented by the calendar interface 220 of FIG. 2B. In this example, the interface 230 presents information about an available segment from New York City to San Francisco with a departure date of Oct. 1, 2018 and a segment that can be created, e.g., in response to client interaction with (e.g., selection of) the date October 1 in the calendar interface 220.

The interface 230 presents information about the available segment and information about a new segment that can be created for departure on October 1. In particular, the interface 230 includes a representative image 231 of the type of jet (light jet) selected for the existing segment and an information element 232 that includes information about the available segment. The information includes the type of jet, the total number of spots on the segment (i.e., 6), the departure time, the number of spots available (i.e., 2), the spot claiming requirement ($1821) for a client to claim a spot on the segment.

Similarly, the interface 230 includes a representative image 233 of a type of jet (light jet) that can be selected for a new client-initiated private jet segment and an information element 234 that includes information about the segment. The information include the type of jet, the total number of spots on the type of jet (i.e., 6), a creation requirement ($14,920) for creating the new client-initiated jet segment using a light jet, the number of spots the client will have access to if the client creates the new segment using the light jet, and the spot claiming requirement that the client would have to submit for each additional spot. The client can scroll down to view similar information for other types of jets that are available for the route from New York to San Francisco on October 1.

If the client wants to create a new client-initiated segment from New York to San Francisco, the client can interact with (e.g., select) the image 233 or the information element 234. In response, the shared flight application 132 can present an interface that enables the client to specify custom attributes for the segment, e.g., departure time, number of spots claimed, whether conditional or confirmed, requested amenities on the jet, client constraints (e.g., allergies that would preclude animals from traveling on the segment), and/or other appropriate attributes. If the client wants to claim a spot on the available segment, the client can interact with (e.g., select) the image 231 or the information element 232. In response, the shared flight application 132 can present a spot selection interface. FIG. 2D is a screenshot of an example spot selection interface 240. The spot selection interface 240 enables the client to select the number of spots on the selected segment. The spot selection interface 240 includes the representative image 231 of the jet selected for the segment and the information element 232 for the segment.

The spot selection interface 240 also includes a spot selection element 241 that presents a spot element for each spot on the segment. For example, the spot selection element 241 includes two available spot elements 242 and four claimed spot elements 243. The claimed spot elements 243 can be presented different from the available spot elements 242 so that clients can quickly and efficiently identify available spots and select which spots the client wants to claim. For example, the claimed spot elements 243 can be presented in a different color or different shading of the same color than the available spot elements.

To claim a spot, the client can interact with one or more available spot elements 242 depending on the number of spots the client wants to claim. The client can then confirm the spots, e.g., by interacting with a confirmation icon or being prompted to provide the required submission for the spot(s).

As described above, if a client modifies an availability of spots on a private jet segment within the shared flight marketplace, the parameters of the private jet segment and other private jet segments can be adjusted. For example, if the client creates a new private jet segment from New York to San Francisco and the new segment includes one or more available spots that other clients in the share flight marketplace can claim, then the total number of spots available on private jet segments from New York to San Francisco has increased (assuming another client did not claim a spot on another segment on this route). In response, the private jet parameter engine 118 can modify the creation requirement for a creator to create a new private jet segment. For example, the private jet parameter engine 118 can increase the creation requirement to encourage finders to claim a spot on one of the available private jet segments from New York to San Francisco rather than create a new private jet segment along this route. In another example, the parameter engine 118 can reduce the spot claiming requirement for a finder to claim a spot on an available private jet segment along this route to encourage finders to claim a spot on one of the available private jet segments along the route.

If the client claims one or more available spots on an existing private jet segment from New York to San Francisco, e.g., using the interface 240, the number of available spots on private jet segments along this route is reduced. In response, the private jet parameter engine 118 can reduce the creation requirement to encourage creators to create new private jet segments from New York to San Francisco to increase the number of spots available on this route. In another example, the parameter engine 118 can increase the spot claiming requirement for a finder to claim a spot on an available private jet segment along this route to encourage creators to create new private jet segments along this route.

FIG. 2E is a screenshot of an updated calendar interface 220 for presenting data specifying the status of segments and required submissions for segments. The calendar interface 220 has been updated relative to the screenshot of FIG. 2B based on a client claiming a spot on the private jet segment from New York to San Francisco on October 1. As shown in the updated calendar interface 220, the spot claiming requirement for a client to claim a spot on the available private jet segment for October 1 has increased from $1821 to $2100. Similarly, the creation requirement for a client to create a new client-initiated private jet segment on October 2-October 6 has been reduced from $14,920 to $12,920. By changing these parameters, clients are encouraged to create new private jet segments on this route, thereby increasing the overall availability of spots on the route to counteract the decrease in availability caused by the client claiming the spot on the segment for October 1.

The calendar interface 220 can be updated in real time (or near real time) in response to a client claiming a spot on an available private jet segment or creating a new client-initiated private jet segment. For example, when a data submission is received that modifies an availability of spots on a private jet segment in the shared flight marketplace, the private jet parameter engine 118 can determine the effect of the modification on the availability of various spots on segments along the same route and modify the parameters of the segments based on the effect. The front-end servers 112 can then transmit the updated parameters to the client devices so that the updated parameters can be presented in the graphical interfaces of the shared flight application 132 (or web pages that present the same or similar content).

Similarly, FIG. 2F is a screenshot of an updated interface 230 that presents information about private jet segments. In the updated interface 230, the number of spots on the available private jet segment from New York to San Francisco on October 1 has been reduced to one based on the client claiming the other available spot. In addition, the spot claiming requirement for the available private jet segment has been updated to $2100. Similarly, the creation requirement to create a new client-initiated jet segment for October 1 has been updated to $12,920.

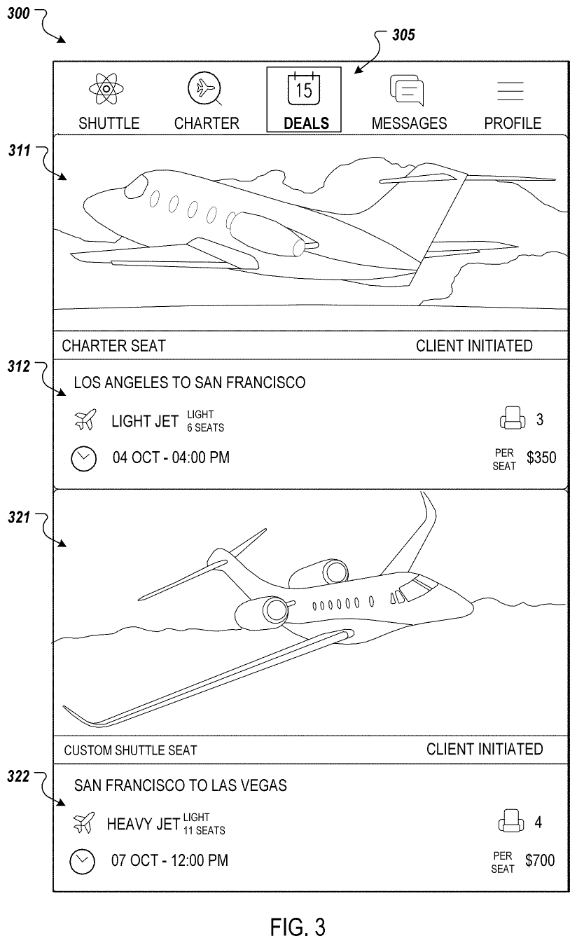

FIG. 3 is a screenshot of an example graphical interface 300 of a shared flight marketplace that presents push notifications sent to a client. The example interface 300 can be presented by the shared flight application 132 (or a web page) in response to client interaction with a “deals” interface control 305. The graphical interface 300 presents information about private jet segments that has been sent to the client via push notifications. For example, the client notification engine 122 can select the client for receiving a push notification for private jet segments based on one or more factors, such as, for each client, a set of client-specified location identifiers specified by the clients as frequent locations for which the client requests to receive notifications, locations that the client has spent at least a threshold amount of time (or was located at least a threshold number of times), the number of times the client has selected to view segment information for (or searched for) routes that have a same geographic identifier as the private jet segment, the number of times the client has claimed a spot on a segment between the same origin and destination as the private jet segment, and/or other appropriate factors.

In this example, the graphical interface 300 presents information about two private segments (a client-initiated shared charter and a client-initiated shuttle) for which the client has received push notification. In particular, the graphical interface 300 includes a representative image 311 of the type of jet (light jet) selected for the shared charter and an information element 311 that includes information about the shared charter. The information includes the route (Los Angeles to San Francisco), the type of jet, the total number of spots on the shared charter (i.e., 6), the departure date and time, the number of spots available (i.e., 3), and the spot claiming requirement ($350) for a client to claim a spot on the shared charter.

The graphical interface 300 also includes a representative image 321 of the type of jet (heavy jet) selected for the shuttle and an information element 322 that includes information about the shuttle. The information includes the route (San Francisco to Las Vegas), the type of jet, the total number of spots on the jet (i.e., 11), the departure date and time, the number of spots available (i.e., 4), and the spot claiming requirement ($700) for a client to claim a spot on the shared charter.

FIG. 4 is a flow chart of an example process 400 for updating parameters that restrict access to spots on private jet segments based on modifications made to spots on private jet segments and communicating the updated parameters to users. Operations of the process 400 can be performed, for example, by one or more data processing apparatus, such as the shared flight marketplace system 110 of FIG. 1. Operations of the process 400 can also be implemented as instructions stored on a non-transitory computer readable medium. Execution of the instructions cause one or more data processing apparatus to perform operations of the process 400.

Data submissions that modify an availability of spots on private jets are received (410). The data submissions, which can be in the form of messages, can be received from users (e.g., clients) operating client devices. The data submissions can include data specifying a spot on a private set segment claimed by a user, data specifying a spot released (e.g., canceled) by a user, or data specifying attributes of a new client-initiated private jet segment created by the user.

The client-initiated private jet segments can include client-initiated custom shuttles, client-initiated conditional shuttles, client-initiated private charters, client-initiated shared charters, and/or other appropriate types of private jet flights. The attributes of a newly created client-initiated private jet segment can include a departure geographic identifier (e.g., an origin city or airport code), a destination geographic identifier (e.g., a destination city or airport code), a departure date (which can include a date and/or time) at which the private jet segment will depart from the origin, a type of jet (e.g., light, midsize, heavy, propeller, rotorcraft, etc.), a number of spots being claimed by the client, and/or other appropriate attributes.

For each modification of the spots caused by the submitted data, one or more parameters that restrict access to other spots are modified based on the effect of the modification (420). For example, the parameter(s) can be modified using constituent operations 421 and 422.

An effect of the modification on the availability of various spots on segments between various geographic locations is determined based on a type of modification made to the available spots (421). The types of modifications can include a claimed spot modification for which one or more spots on a given private jet segment have been claimed by a user. The effect of such a modification can include a decrease in the number of available spots on the given private jet segment based on the user claiming the one or more spots on the given private jet segment.

Another type of modification is a new segment modification for which a new client-initiated private jet segment for a given route has been created by a user. The effect of such a modification can include an increase in available spots on private jet segments along the given route. The increase in the number of spots can be the number of available spots on the new client-initiated private jet segment.

Another type of modification is a new conditional segment modification for which a new client-initiated conditional private jet segment has been created by a user. As described above, a conditional private jet segment is conditional until at least a threshold number of spots on the segment are claimed or an expiration time elapses. The effect of the creation of a conditional private jet segment on a given route can include an increase in available spots on private jet segments along the given route. However, if the conditional private jet segment is cancelled due to the expiration time elapsing, the number of available spots on private jet segments along the route can decrease by the number of spots that were available on the conditional private jet segment.

Another type of modification is a charter conversion modification in which a user has converted a private charter segment to a shared charter segment on which other users can claim a spot. The effect of converting a private charter segment on a given route to a shared charter segment on the given route can include an increase in the number of available spots on the given route. The number of available spots can be increased by the number of available spots on the shard charter segment.

Another type of modification is a segment list modification in which a user adds a private jet segment for a given route to a segment list (e.g., a wish list) of the user. The effect of such a modification. Generally speaking, when a client places a segment in a segment list, the client is expressing an interest in that segment. The effect of such a modification can include an increase in the number of users that have added the private jet segment to segments lists. An increase in the number of users that have added the private jet segment to segments lists indicates increased interest in the private jet segment and the given route in general.

One or more parameters that restrict access to other spots are modified based on the effect of the modification (422). The one or more parameters can include a creation requirement for a user to create a new private jet segment and/or a spot claiming requirement for a user to claim a spot on an available private jet segment. The amounts of these parameters can be express in dollars, other currencies, or other items of values such as internal credits (e.g., renewable tokens or other forms of credits).

In general, modifications that cause a decrease in the number of available spots for a private jet segment or for a route results in a decrease in the creation requirement for a user to create a new client-initiated jet segment along the route. For example, the creation requirement for a user to create a new client-initiated segment on a route can be decreased in response to a user claiming a spot on an available private jet segment on the route. The amount of decrease in the creation requirement can correspond to (e.g., be proportional to) the reduction in the number of spots or to the total number of available spots remaining on the private segment or the route.

When determining the adjustment to the creation requirement for a given route in response to an increase or decrease in the number of spots on private jet segments along the given route, the departure dates can be considered. For example, the creation requirement for a given date can be based on the number of available spots on private jet segments that will depart on the given route within a threshold number of days of the given date. If the number of available spots changes for segments on the given route that depart outside of this time period, it may not affect the creation requirement for the given date. For example, if the given date is October 4 and the threshold number of days is three, then the time period of interest for the given date is October 1-October 7. If a client claims a spot on a private jet segment on the given route that departs on September 30, this may not affect the creation requirement for creating a new segment on the given route with a departure date of October 1. However, if a client claims a spot on a private jet segment on the given route that departs on October 1, the creation requirement for creating a new segment on the given route with a departure date of October 1 can be reduced.

Modifications that cause a decrease in the number of available spots for a given private jet segment can also result in an increase in the spot claiming requirement for claiming a spot on the given private jet segment. Similarly, this decrease in the number of available spots for a given private jet segment can also result in an increase in the spot claiming requirement for claiming a spot on other private jet segments on the same route as the given private jet segment. For example, the spot claiming requirement can be reduced for private jet segments on the same route that depart within a threshold number of days of the given private jet segment.

In general, modifications that cause an increase in the number of available spots for a private jet segment or for a route results in an increase in the creation requirement for a user to create a new client-initiated jet segment along the route. For example, the creation requirement for a user to create a new client-initiated segment on a route can be increased in response to a user creating a new private jet segment on the route. The amount of increase in the creation requirement can correspond to (e.g., be proportional to) the reduction in the number of spots or to the total number of available spots remaining on the private segment or the route. Similarly, modifications that cause an increase in the number of available spots for a private jet segment or a route results in a decrease in the spot claiming requirement for users to claim a spot on the private jet segment or the route.

The adjustments to the creation requirement and/or the spot claiming requirement can be based on the type of modification. For example, the adjustments for a private jet shuttle can differ from the adjustments for conditional segments which can also differ from the adjustments for shared charters.

An increase in the number of users that add a given private jet segment to their segment lists can result in an increase in the spot claiming requirement for users to claim a spot on the given private jet segment. Such an increase can also result in an increase in the creation requirement for a user to create a new client-initiated segment on the same route as the given private jet segment.

The modified parameters are communicated to users (430). The modified parameter(s) can be communicated to users through a user interface that presents access restrictions for various spots on private jets and/or push message alerts to at least one of the users in response to the modification of the parameter(s). For example, the modified parameter(s) can be presented in calendar interfaces and other interfaces as described above. The modified parameter(s) can also be sent to at least a portion of the users via push notifications. For example, push notification alerts that include the modified parameter(s) can be provided to users that have shown interest in the segment or route for which the parameter(s) have been modified.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for providing a shared flight marketplace, the system comprising:
one or more front-end servers that interact, over a data communication network, with client devices of users; and
one or more back-end servers in data communication with the one or more front-end servers and that include one or more data processors, the one or more front-end servers or the one or more back-end servers being configured to perform operations comprising:
receiving, from users operating client devices, data submissions that modify an availability of spots on private jets;
for each modification of the spots caused by the submitted data:
determining, based on a type of modification made to the availability of the spots, an effect of the modification on the availability of various spots on segments between various geographic locations; and
modifying one or more parameters that restrict access to the other spots based on the effect of the modification, including adjusting a creation requirement for users to create a new private jet segment based on the effect of the modification; and
communicating the modified one or more parameters to users through a user interface that presents access restrictions for various spots on private jets and through a push message alert to at least one of the users in response to the modification of the one or more parameters.

2. The system of claim 1, wherein:
determining the effect comprises determining that the modification causes a decrease in available spots for a given private jet segment based on a user claiming a spot on the given private jet segment; and
modifying the one or more parameters comprises decreasing an amount required to create a new private jet segment having a same route as the given private jet segment based on the decreased availability of spots on segments on the same route in response to the user claiming the spot.

3. The system of claim 1, wherein:
determining the effect comprises determining that the modification is a user creating a new private jet segment for a given route that causes an increase in available spots on private jet segments along the given route; and
modifying the one or more parameters comprises increasing the creation requirement for a user to create a new private jet segment along the given route based on the increased availability of spots on private jet segments on the given route.

4. The system of claim 3, wherein increasing the creation requirement comprises increasing the creation requirement based on a quantity of additional available spots on the given route added by the new private jet segment.

5. The system of claim 3, wherein the new private jet segment is a new conditional private jet segment that is conditional on at least a threshold number of spots on the new conditional private jet segment being claimed, the operations further comprising:
determining that an expiration time for the conditional private jet segment has elapsed;
cancelling the new conditional private jet segment in response to the expiration time elapsing causing decrease in available spots on private jet segments along the given route; and
decreasing the creation requirement for a user to create a new private jet segment along the given route based on the decreased availability of spots on private jet segments on the given route.

6. The system of claim 1, wherein the operations comprise, in response to determining that the modification is a user creating a new private jet segment along a given route, identifying an aircraft that is available to complete the private jet segment along the given route, wherein the aircraft is selected from among a candidate fleet including an owned private aircraft fleet and a third party private aircraft fleet owned by a third party.

7. The system of claim 1, wherein:
determining the effect comprises:
determining that the modification is a user converting a private charter segment created by the user for a given route to a shared charter segment on which other users can claim a spot; and
determining that the shared charter segment includes one or more available spots that causes an increase in available spots on private jet segments along the given route; and
modifying the one or more parameters comprises increasing the creation requirement for users to create a new private jet segment along the given route based on the increased availability of spots on private jet segments on the given route.

8. The system of claim 1, wherein:
determining the effect comprises determining that the modification is a user claiming a spot on a private jet segment for a given route that causes a decrease in available spots on private jet segments along the given route; and
modifying the one or more parameters comprises:
determining that there is at least one remaining available spot on the private jet segment; and
increasing a spot claiming requirement for users to claim a spot on the private jet segment based on the decreased availability of spots on private jet segments on the given route.

9. The system of claim 1, wherein:
determining the effect comprises determining that the modification is a user adding a private jet segment for a given route to a segment list of the user that causes an increase in a number of users that have added the private jet segment to segment lists; and
modifying the one or more parameters comprises increasing a spot claiming requirement for users to claim a spot on the private jet segment based on the increase in the number of users that have added private jet segments for the given route to segment lists.

10. The system of claim 1, wherein the data submission comprises data specifying at least one of (i) a spot claimed on a private jet segment, (ii) a new client-initiated private jet shuttle, (iii) a new client-initiated private jet charter, or (iv) a new client-initiated conditional private jet segment.

11. A computer implemented method of providing a shared flight marketplace, comprising:
receiving, by one or more computers and from users operating client devices, data submissions that modify an availability of spots on private jets;
for each modification of the spots caused by the submitted data:
determining, based on a type of modification made to the availability of the spots, an effect of the modification on the availability of various spots on segments between various geographic locations; and
modifying, by the one or more computers, one or more parameters that restrict access to the other spots based on the effect of the modification, including adjusting a creation requirement for users to create a new private jet segment based on the effect of the modification; and
communicating, by the one or more computers, the modified one or more parameters to users through a user interface that presents access restrictions for various spots on private jets and through a push message alert to at least one of the users in response to the modification of the one or more parameters.

12. The method of claim 11, wherein:
determining the effect comprises determining that the modification causes a decrease in available spots for a given private jet segment based on a user claiming a spot on the given private jet segment; and
modifying the one or more parameters comprises decreasing an amount required to create a new private jet segment having a same route as the given private jet segment based on the decreased availability of spots on segments on the same route in response to the user claiming the spot.

13. The method of claim 11, wherein:
determining the effect comprises determining that the modification is a user creating a new private jet segment for a given route that causes an increase in available spots on private jet segments along the given route; and
modifying the one or more parameters comprises increasing the creation requirement for a user to create a new private jet segment along the given route based on the increased availability of spots on private jet segments on the given route.

14. The method of claim 13, wherein increasing the creation requirement comprises increasing the creation requirement based on a quantity of additional available spots on the given route added by the new private jet segment.

15. The method of claim 13, wherein the new private jet segment is a new conditional private jet segment that is conditional on at least a threshold number of spots on the new conditional private jet segment being claimed, the method further comprising:
determining that an expiration time for the conditional private jet segment has elapsed;
cancelling the new conditional private jet segment in response to the expiration time elapsing causing decrease in available spots on private jet segments along the given route; and
decreasing the creation requirement for a user to create a new private jet segment along the given route based on the decreased availability of spots on private jet segments on the given route.

16. The method of claim 11, further comprising, in response to determining that the modification is a user creating a new private jet segment along a given route, identifying an aircraft that is available to complete the private jet segment along the given route, wherein the aircraft is selected from among a candidate fleet including an owned private aircraft fleet and a third party private aircraft fleet owned by a third party.

17. The method of claim 11, wherein:
determining the effect comprises:
determining that the modification is a user converting a private charter segment created by the user for a given route to a shared charter segment on which other users can claim a spot; and
determining that the shared charter segment includes one or more available spots that causes an increase in available spots on private jet segments along the given route; and
modifying the one or more parameters comprises increasing the creation requirement for users to create a new private jet segment along the given route based on the increased availability of spots on private jet segments on the given route.

18. The method of claim 11, wherein:
determining the effect comprises determining that the modification is a user claiming a spot on a private jet segment for a given route that causes a decrease in available spots on private jet segments along the given route; and
modifying the one or more parameters comprises:
determining that there is at least one remaining available spot on the private jet segment; and
increasing a spot claiming requirement for users to claim a spot on the private jet segment based on the decreased availability of spots on private jet segments on the given route.

19. The method of claim 11, wherein:
determining the effect comprises determining that the modification is a user adding a private jet segment for a given route to a segment list of the user that causes an increase in a number of users that have added the private jet segment to segment lists; and
modifying the one or more parameters comprises increasing a spot claiming requirement for users to claim a spot on the private jet segment based on the increase in the number of users that have added private jet segments for the given route to segment lists.

20. A non-transitory computer storage medium encoded with a computer program, the program comprising instructions that when executed by data processing apparatus cause the data processing apparatus to perform operations comprising:
receiving, from users operating client devices, data submissions that modify an availability of spots on private jets;
for each modification of the spots caused by the submitted data:
determining, based on a type of modification made to the availability of the spots, an effect of the modification on the availability of various spots on segments between various geographic locations; and
modifying one or more parameters that restrict access to the other spots based on the effect of the modification, including adjusting a creation requirement for users to create a new private jet segment based on the effect of the modification; and
communicating the modified one or more parameters to users through a user interface that presents access restrictions for various spots on private jets and through a push message alert to at least one of the users in response to the modification of the one or more parameters.
